(19) United States
(12) Patent Application Publication
(10) Pub. No.: US 2016/0275271 A1
(43) Pub. Date: Sep. 22, 2016

(54) User Terminal And Method For Protecting Core Codes Using Peripheral Device of User Terminal

(71) Applicant: SOONGSIL UNIVERSITY RESEARCH CONSORTIUM TECHNO- PARK, Seoul (KR)

(72) Inventors: Jeong-Hyun Yi, Seongnam-si (KR); Yongjin Park, Seoul (KR)

(21) Appl. No.: 14/785,637

(22) PCT Filed: Mar. 6, 2015
(86) PCT No.: PCT/KR2015/002205

§ 371 Date: Oct. 20, 2015

(30) Foreign Application Priority Data
Oct. 21, 2014 (KR) 10-2014-0142689
Jan. 8, 2015 (KR) 10-2015-0002942

(51) Int. Cl. G06F 21/12; G06F 9/445; H04W 12/04; G06F 21/60; H04L 29/06

(52) U.S. Cl. CPC G06F 21/12; G06F 21/602; H04L 63/06; H04W 12/04; H04L 63/0876; H04L 63/0428; G06F 8/61

(57) ABSTRACT

A user terminal includes a pairing circuit, a communication circuit, and a control circuit. The pairing circuit receives a normal code of an application from an application providing server in a process of downloading and installing the application from the application providing server, and performs a pairing operation with a peripheral device that stores a core code of the application received from the application providing server. The communication circuit, in a process of executing the application, transmits distinct information of the user terminal to the peripheral device to make the peripheral device encrypt the core code and decrypt the encrypted core code. The control circuit transmits an execution request message to the peripheral device, and receives an execution result of the core code from the peripheral device.

### THE ART TO WHICH THE INVENTIVE CONCEPT

Example embodiments generally relate to user terminals and methods for protecting core codes using peripheral devices of the user terminals, and more particularly relate to user terminals that are able to protect core codes of applications from reverse engineering attacks and methods for protecting core codes of applications using peripheral devices of the user terminals.

### BACKGROUND OF THE INVENTIVE CONCEPT

Smart phone users are able to receive various kinds of services by downloading applications and contents, which are developed by a third party, from digital open markets, such as Google Play, and executing the applications. As a result, a lot of data are stored in a smart phone. Sensitive data or secure data may also be stored in a smart phone, such that security technologies have been developed to protect the sensitive data or the secure data.

Data, which include financial information, personal information, etc., stored in a smart phone may be leaked by a tampered application as well as by phishing, pharming, smishing, etc. Attackers extract a decompiled source code by performing a reverse engineering on an application and generate a tampered application by inserting a malicious code in the decompiled source code. Sometimes, attackers get economic benefit by illegally using the decompiled source code.

Particularly, compared to iphone applications, Android applications are easily analyzed to extract a decompiled source code from the application, such that Android applications are targeted by hackers to generate a tampered application.

Various kinds of source code obfuscate technologies and LVL (Licensing Verification Library) of Google, which increase time for analyzing an application or make it difficult to perform a reverse engineering, have been developed to prevent illegal copy of an application and application tampering.

However, technologies that make it impossible to extract a decompiled source code from an application or make it impossible to analyze an application are required to basically protect an application and user information.

The background art of the present invention has been described in Korean Patent Registration Publication No. 10-1223981 (2013, Jan. 21).

### CONTENT OF THE INVENTIVE CONCEPT

### Technical Object of the Inventive Concept

Some example embodiments of the inventive concept provide a user terminal that is able to protect core codes of an application from reverse engineering attacks and a method for protecting core codes of an application using a peripheral device of the user terminal.

### Means for Achieving the Technical Object

According to example embodiments, a user terminal includes a pairing circuit, a communication circuit, and a control circuit. The pairing circuit receives a normal code of an application from an application providing server in a process of downloading and installing the application from the application providing server, and performs a pairing operation with a peripheral device that stores a core code of the application received from the application providing server. The communication circuit, in a process of executing the application, transmits distinct information of the user terminal to the peripheral device to make the peripheral device encrypt the core code and decrypt the encrypted core code. The control circuit transmits an execution request message to the peripheral device, and receives an execution result of the core code from the peripheral device.

The user terminal may further comprise a display device that displays the execution result of the core code.

When an execution command of the application is received for the first time, the peripheral device may encrypt the core code using the distinct information of the user terminal and store the encrypted core code. When the execution command of the application is received again, the peripheral device may decrypt the encrypted core code using the distinct information of the user terminal, execute the decrypted core code, and transmits the execution result of the decrypted core code to the user terminal.

The distinct information of the user terminal may include an international mobile equipment identity (IMEI). The peripheral device may encrypt the core code using the distinct information of the user terminal and decrypt the encrypted core code using the distinct information of the user terminal.

In a method for protecting a core code using a user terminal, the user terminal receives a normal code of an application from an application providing server in a process of downloading and installing the application from the application providing server, performs a pairing operation with a peripheral device that stores a core code of the application received from the application providing server, transmits, in a process of executing the application for the first time, distinct information of the user terminal to the peripheral device to make the peripheral device encrypt the core code, transmits, in a process of executing the application again, the distinct information of the user terminal to the peripheral device to make the peripheral device decrypt the encrypted core code, transmits an execution request message to the peripheral device, and receives an execution result of the core code from the peripheral device.

### Effects of the Inventive Concept

Since the core code of the application is stored in the peripheral device, which is paired with the user terminal, and the peripheral device executes the core code of the application, the core code of the application may not be exposed to the user terminal. Therefore, the core code of the application may be protected from reverse engineering attacks.

In addition, the peripheral device may store the encrypted core code that is encrypted using the distinct information of the user terminal Therefore, although one of the user terminal and the peripheral device is stolen, the acquirer may not be able to execute the application. As such, an illegal use of the application may be effectively prevented.

### BRIEF DESCRIPTION OF THE DRAWINGS

FIG. 1 is a diagram illustrating a system for protecting a core code according to example embodiments.

FIG. 2 is a block diagram illustrating a user terminal according to example embodiments.

FIG. 3 is a block diagram illustrating a peripheral device according to example embodiments.

FIG. 4 is a flow chart illustrating a method for protecting a core code according to example embodiments.

### PARTICULAR CONTENTS FOR IMPLEMENTING THE INVENTIVE CONCEPT

Various example embodiments will be described more fully with reference to the accompanying drawings, in which some example embodiments are shown. The present inventive concept may, however, be embodied in many different forms and should not be construed as limited to the embodiments set forth herein. Rather, these embodiments are provided so that this disclosure will be thorough and complete, and will fully convey the scope of the present inventive concept to those skilled in the art. Like reference numerals refer to like elements throughout this application.

Hereinafter, various example embodiments will be described fully with reference to the accompanying drawings.

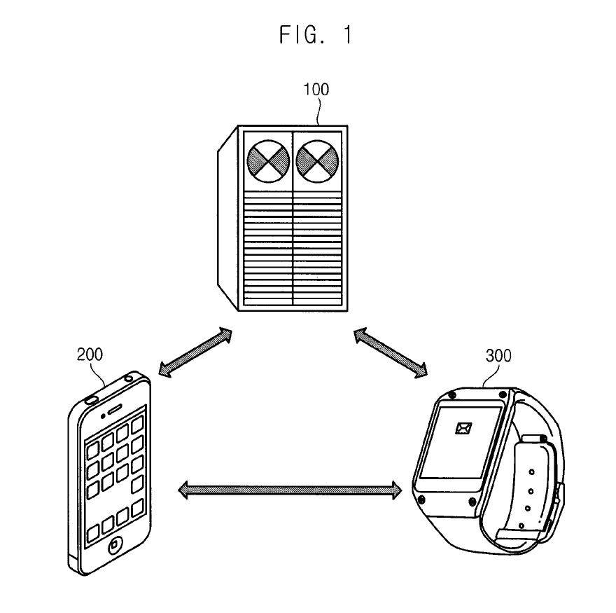

FIG. 1 is a diagram illustrating a system for protecting a core code according to example embodiments.

Referring to FIG. 1, a system for protecting a core code includes an application providing server 100, a user terminal 200, and a peripheral device 300.

As illustrated in FIG. 1, the application providing server 100, the user terminal 200, and the peripheral device 300 may be connected by a network. That is, the user terminal 200 may be connected to the application providing server 100 and the peripheral device 300 by a network, and the peripheral device 300 may be connected to the application providing server 100 by a network.

Here, the network represents a connection structure capable of communicating data among nodes such as user terminals, servers, etc. The network may include an internet, local area network (LAN), wireless LAN, wide area network (WAN), personal area network (PAN), 3G network, 4G network, Wi-Fi, etc.

In some example embodiments, the user terminal 200 and the peripheral device 300 may be coupled wirelessly by Bluetooth, ZigBee, infrared data association (IrDA), etc. In other example embodiments, the user terminal 200 and the peripheral device 300 may be coupled by a wire.

The application providing server 100 may divide an application file into a core code and a normal code. The application providing server 100 may provide the core code to the peripheral device 300 and provide the normal code to the user terminal 200.

The application providing server 100 may define the core code using an execution file, which is generated by decompiling an application package. The application providing server 100 may generate the normal code by deleting the core code from the application file. Each of the core code and the normal code may have an executable file format such that the core code and the normal code may be installed in the peripheral device 300 and the user terminal 200, respectively.

The application providing server 100 according to example embodiments may store normal codes and core codes of various kinds of applications, such as a finance application, a news application, a shopping application, a game application, etc. The user terminal 200 and the peripheral device 300 may download and install the normal code and the core code of the application, respectively, from the application providing server 100. In some example embodiments, the application providing server 100 may correspond to a mobile application market. For example, the application providing server 100 may correspond to Google Play, App Store of Apple, etc.

The user terminal 200 may receive the normal code of the application from the application providing server 100 and install the normal code of the application in the user terminal 200. When the application is executed for the first time, the user terminal 200 may transmit distinct information of the user terminal 200 to the peripheral device 300, which is paired with the user terminal 200, and the peripheral device 300 may encrypt the core code using the distinct information of the user terminal 200. When the application is executed again, the user terminal 200 may receive an execution result of the core code from the peripheral device 300. The user terminal 200 may apply the execution result of the core code to the execution of the application or display the execution result of the core code.

The user terminal 200 may correspond to any terminal that is able to install an application and execute the application. For example, the user terminal 200 may include a smart phone, a smart pad, a cellular phone, a laptop computer, a tablet computer, a personal digital assistant (PDA), etc.

Here, the application represents a program executable on a terminal. For example, the application may include an app that is executed on a mobile terminal such as a smart phone. The user may download the application from a mobile application market at which mobile contents are traded, and install the application on the user terminal 200.

The peripheral device 300 may receive the core code of the application from the application providing server 100 and store the core code of the application. The peripheral device 300 may receive the distinct information of the user terminal 200 from the user terminal 200, which is paired with the peripheral device 300, and encrypt the core code using the distinct information of the user terminal 200. When the application is executed again on the user terminal 200 such that the user terminal 200 transmits the distinct information of the user terminal 200 and an execution request message to the peripheral device 300, the peripheral device 300 may decrypt the encrypted core code using the distinct information of the user terminal 200, execute the decrypted core code, and transmit the execution result of the decrypted core code to the user terminal 200.

In some example embodiments, the peripheral device 300 may display the execution result of the decrypted core code on a display device of the peripheral device 300 or output the execution result of the decrypted core code as a sound.

The peripheral device 300 may correspond to any electronic device including a central processing unit (CPU) that is able to communicate with the user terminal 200 and the application providing server 100, to receive and store the core code of the application, and to execute the core code of the application. For example, the peripheral device 300 may include a wearable device, such as a smart watch, a smart glasses, a smart band, etc.

In some example embodiments, the peripheral device 300 may include an appcessory, such as an activity tracker, a mobile photo printer, a home monitoring device, a toy, a medical device, etc. Here, appcessory represents an accessory that broadens functions of the user terminal 200 (e.g., smart phone) in association with an application.

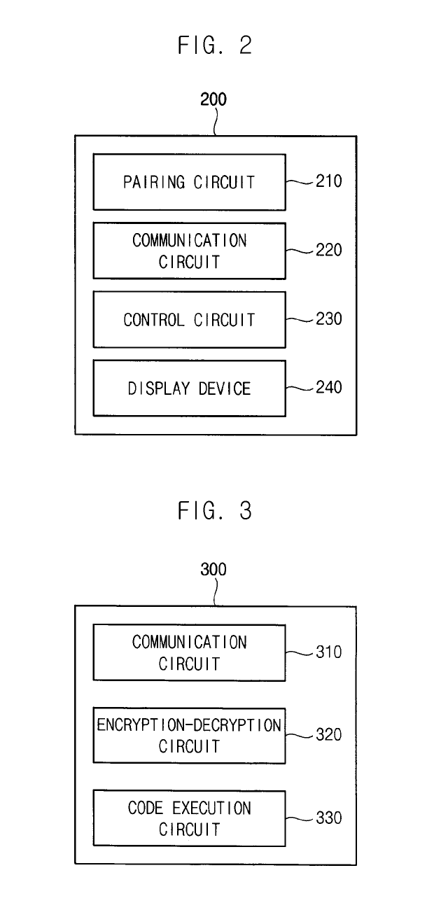

FIG. 2 is a block diagram illustrating a user terminal according to example embodiments.

Referring to FIG. 2, a user terminal 200 may include a pairing circuit 210, a communication circuit 220, a control circuit 230, and a display device 240.

The pairing circuit 210 may communicate with the application providing server 100 and the peripheral device 300. In some example embodiments, the pairing circuit 210 may communicate with the application providing server 100 by a wireless communication scheme, such as Wi-Fi, 3G network, 4G network, long term evolution (LTE), Wibro, etc., and communicate with the peripheral device 300 by a wireless communication scheme, such as Bluetooth, ZigBee, infrared data association (IrDA), etc., or a wired communication scheme.

The pairing circuit 210 may receive the normal code of the application from the application providing server 100, and install the application on the user terminal 200. In addition, the pairing circuit 210 may perform a pairing operation with the peripheral device 300, which downloaded the core code of the application from the application providing server 100.

The communication circuit 220 may transmit the distinct information of the user terminal 200 to the peripheral device 300. The distinct information of the user terminal 200 may include an international mobile equipment identity (IMEI). In some example embodiments, the communication circuit 220 may transmit the distinct information of the user terminal 200 to the peripheral device 300 by a near field communication, such as Bluetooth, ZigBee, infrared data association (IrDA), etc., or a wired communication.

The control circuit 230 may transmit the execution request message, which includes information of a required core code, to the peripheral device 300 in the process of executing the normal code, and receive the execution result of the required core code from the peripheral device 300. In some example embodiments, the control circuit 230 may transmit the execution request message to the peripheral device 300 and receive the execution result of the required core code from the peripheral device 300 by a near field communication, such as Bluetooth, ZigBee, infrared data association (IrDA), etc., or a wired communication.

The display device 240 may display the execution result of the required core code. In some example embodiments, the display device 240 may output the execution result of the required core code as various kinds of forms such that the user is able to recognize by sight, hearing, touch, etc.

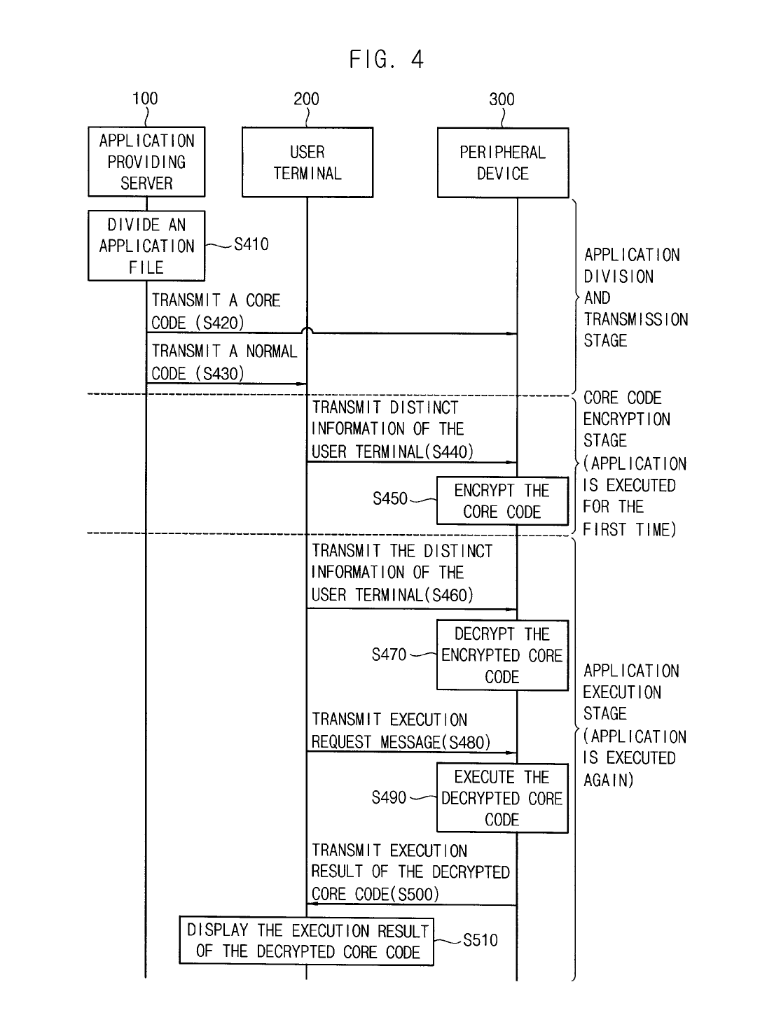

FIG. 3 is a block diagram illustrating a peripheral device according to example embodiments.

Referring to FIG. 3, a peripheral device 300 may include a communication circuit 310, an encryption-decryption circuit 320, and a code execution circuit 330.

The communication circuit 310 may communicate with the application providing server 100 and the user terminal 200. In some example embodiments, the communication circuit 310 may communicate with the user terminal 200 by a near field communication, such as Bluetooth, ZigBee, infrared data association (IrDA), etc., or a wired communication.

The communication circuit 310 may receive the core code of the application from the application providing server 100, and install the core code of the application in the peripheral device 300. When the application is executed on the user terminal 200, the communication circuit 310 may receive the distinct information of the user terminal 200 and the execution request message from the user terminal 200.

When the application is executed on the user terminal 200 for the first time such that a core code encryption stage starts, the encryption-decryption circuit 320 may encrypt the core code using the distinct information of the user terminal 200, which is received from the user terminal 200, and store the encrypted core code in the peripheral device 300. When the application is executed again on the user terminal 200, the encryption-decryption circuit 320 may decrypt the encrypted core code using the distinct information of the user terminal 200, which is received from the user terminal 200.

When receiving the execution request message from the user terminal 200, the code execution circuit 330 may load the decrypted core code, execute the decrypted core code, and transmit the execution result of the decrypted core code to the user terminal 200.

Hereinafter, a method for protecting a core code of an application using a peripheral device of a user terminal according to example embodiments will be described with reference to FIG. 4.

FIG. 4 is a flow chart illustrating a method for protecting a core code according to example embodiments.

In the method for protecting a core code of an application using a peripheral device of a user terminal of FIG. 4, an application division and transmission stage may include steps S410 to S430, the core code encryption stage may include steps S440 and S450, and an application execution stage may include steps S460 to S510.

At first, the application providing server 100 may perform the application division and transmission stage through the steps S410 to S430.

The application providing server 100 may divide the application file into the core code and the normal code (step S410). For example, the application providing server 100 may define the core code using the execution file, which is generated by decompiling an application package. The application providing server 100 may generate the normal code by deleting the core code from the application file.

The application providing server 100 may transmit the core code to the peripheral device 300 (step S420). In some example embodiments, the application providing server 100 may transmit the core code to the peripheral device 300 by a wireless communication scheme, such as Wi-Fi, 3G network, 4G network, long term evolution (LTE), Wibro, etc., or by a near field communication or a wired communication to increase a security level.

When the user terminal 200 connects to the application providing server 100, the application providing server 100 may transmit the normal code to the user terminal 200 using a download scheme (step S430). The user terminal 200 may download the normal code of the application through a network, such as 3G network, 4G network, Wi-Fi, etc., and installs the application using the normal code.

After finishing the application division and transmission stage, when the user terminal 200 receives a command from the user to execute the application, which is installed in the user terminal 200, for the first time, the user terminal 200 and the peripheral device 300 may perform an encryption operation of the core code through steps S440 and S450. On the other hand, when the user terminal 200 receives a command from the user to execute the application, which is installed in the user terminal 200, again, the user terminal 200 and the peripheral device 300 may perform an execution operation of the application through steps S460 and S510.

When the user terminal 200 receives a command from the user to execute the application, which is installed in the user terminal 200, for the first time, the user terminal 200 may perform a pairing operation with the peripheral device 300. In some example embodiments, the user terminal 200 may perform a pairing operation with the peripheral device 300, which is distributed or sold after the core code is stored in the peripheral device 300. In other example embodiments, the user terminal 200 may perform a pairing operation with the peripheral device 300 after the peripheral device 300 downloads the core code from the application providing server 100.

In some example embodiments, the user terminal 200 may be paired with the peripheral device 300 during the core code encryption stage. However, example embodiments are not limited thereto. According to example embodiments, the user terminal 200 may be paired with the peripheral device 300 during the application division and transmission stage.

After the user terminal 200 is paired with the peripheral device 300, the user terminal 200 may transmit the distinct information of the user terminal 200 to the peripheral device 300 (step S440). The distinct information of the user terminal 200 may include an international mobile equipment identity (IMEI).

The international mobile equipment identity (IMEI) is a distinct identification number that is assigned to each of cellular phones. According to a guideline of a global system for mobile communications association (GSMA), every producers of cellular phones assign the international mobile equipment identity (IMEI) to each of the cellular phones. The international mobile equipment identity (IMEI) includes 15 digits (8 digits of an approval code, 6 digits of a model serial number, and a check digit). The international mobile equipment identity (IMEI) is managed under a white list and a black list. The international mobile equipment identity (IMEI) is used for stopping a stolen phone from accessing a network.

In addition, the user terminal 200 may transmit identification information of the application that is required to be encrypted, together with the distinct information of the user terminal 200, to the peripheral device 300 during the step S440. The peripheral device 300 may store a plurality of applications. The peripheral device 300 may determine an application, which is requested by the user terminal 200, among the plurality of applications stored in the peripheral device 300 using the identification information of the application received from the user terminal 200.

The peripheral device 300 may encrypt the core code of the application, which is received during the step S420 (step S450). For example, the peripheral device 300 may encrypt the core code of the application, which corresponds to the identification information, using the distinct information of the user terminal 200 that is received during the step S440.

Although FIG. 4 illustrates that the peripheral device 300 encrypts the core code using the distinct information of the user terminal 200 that is received from the user terminal 200, example embodiments are not limited thereto. According to example embodiments, the application providing server 100 may receive the distinct information of the user terminal 200 from the user terminal 200, encrypt the core code using the distinct information of the user terminal 200, and transmit the encrypted core code to the peripheral device 300 during the step S420. In this case, the steps S440 and S450 may be omitted.

In the system for protecting a core code according to example embodiments, the international mobile equipment identity (IMEI) of the user terminal 200 may be used as a key to encrypt the core code and to decrypt the encrypted core code. Since the peripheral device 300 performs the encryption operation and the decryption operation using the international mobile equipment identity (IMEI) of the user terminal 200, the encrypted core code, which is stored in the peripheral device 300, may be subordinated to the user terminal 200.

When the application is executed again on the user terminal 200, the user terminal 200 and the peripheral device 300 may perform the application execution stage using the steps S460 to S510.

The user terminal 200 may transmit the distinct information of the user terminal 200 to the peripheral device 300 (step S460). In some example embodiments, the distinct information of the user terminal 200 may include the international mobile equipment identity (IMEI) of the user terminal 200. The user terminal 200 may transmit the identification information of the application that is requested to be executed by the user, together with the distinct information of the user terminal 200, to the peripheral device 300.

The peripheral device 300 may decrypt the encrypted core code of the application, which corresponds to the identification information, using the distinct information of the user terminal 200 (step S470). As described above, the encrypted core code, which is encrypted using the distinct information of the user terminal 200 during the step S450, may be subordinated to the user terminal 200 that transmitted the distinct information to the peripheral device 300 during the step S440. Therefore, although the peripheral device 300 storing the encrypted core code is stolen, the encrypted core code may not be decrypted by other user terminal.

The user terminal 200 may transmit the execution request message to the peripheral device 300 (step S480). Although FIG. 4 illustrates that the user terminal 200 transmits the execution request message to the peripheral device 300 (step S480) after the user terminal 200 transmits the distinct information of the user terminal 200 to the peripheral device 300 (step S460), example embodiments are not limited thereto. According to example embodiments, the user terminal 200 may transmit the execution request message, together with the distinct information of the user terminal 200, to the peripheral device 300 during the step S460.

The execution request message may correspond to a message requesting the peripheral device 300 to execute the core code of the application that is stored in the peripheral device 300. The execution request message may include the identification information of the application that is requested to be executed and information of file or function to be called.

The peripheral device 300 may execute the decrypted core code, which corresponds to the execution request message received from the user terminal 200 (step S490).

When the execution request message includes a name of a function to be called, the peripheral device 300 may load and execute the function.

The normal code transmitted from the application providing server 100 to the user terminal 200 during the step S430 may correspond to a main routine, and the core code transmitted from the application providing server 100 to the peripheral device 300 during the step S420 may correspond to a sub routine.

When the user terminal 200 executes the normal code according to an execution command from the user, the normal code, which corresponds to the main routine, may call the sub routine such that the peripheral device 300 may execute the decrypted core code, which is decrypted during the step S470. That is, the user terminal 200 may transmit the execution request message to the peripheral device 300 by executing the normal code to make the peripheral device 300 execute the core code.

The peripheral device 300 may transmit the execution result of the decrypted core code of the application to the user terminal 200 (step S500), and the user terminal 200 may display the execution result on the display device 240 (step S510).

Although FIG. 4 illustrates that the user terminal 200 displays the execution result of the decrypted core code of the application, which is received from the peripheral device 300, on the display device 240, example embodiments are not limited thereto. When the peripheral device 300 includes an output device, the peripheral device 300 may output the execution result of the decrypted core code of the application through the output device of the peripheral device 300 and the steps S500 and S510 may be omitted.

In this case, the user may check the execution result from the output device of the peripheral device 300 and input the execution result to the user terminal 200 to execute the application.

As described above, according to the present inventive concept, since the core code of the application is stored in the peripheral device 300, which is paired with the user terminal 200, and the peripheral device 300 executes the core code of the application, the core code of the application may not be exposed to the user terminal 200. Therefore, the core code of the application may be protected from reverse engineering attacks.

In addition, the peripheral device 300 may store the encrypted core code that is encrypted using the distinct information of the user terminal 200. Therefore, although one of the user terminal 200 and the peripheral device 300 is stolen, the acquirer may not be able to execute the application. As such, an illegal use of the application may be effectively prevented.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

### REFERENCE NUMERALS

100: application providing server
200: user terminal
210: pairing circuit
220: communication circuit
230: control circuit
240: display device
300: peripheral device
310: communication circuit
320: encryption-decryption circuit
330: code execution circuit

What is claimed is:

1. A user terminal, comprising:
a pairing circuit configured to receive a normal code of an application from an application providing server in a process of downloading and installing the application from the application providing server, and to perform a pairing operation with a peripheral device that stores a core code of the application received from the application providing server;
a communication circuit configured, in a process of executing the application, to transmit distinct information of the user terminal to the peripheral device to make the peripheral device encrypt the core code and decrypt the encrypted core code; and
a control circuit configured to transmit an execution request message to the peripheral device, and to receive an execution result of the core code from the peripheral device.

2. The user terminal of claim 1, further comprising:
a display device configured to display the execution result of the core code.

3. The user terminal of claim 1, wherein,
when an execution command of the application is received for the first time, the peripheral device encrypts the core code using the distinct information of the user terminal and stores the encrypted core code, and
when the execution command of the application is received again, the peripheral device decrypts the encrypted core code using the distinct information of the user terminal, executes the decrypted core code, and transmits the execution result of the decrypted core code to the user terminal.

4. The user terminal of claim 3, wherein the distinct information of the user terminal includes an international mobile equipment identity (IMEI), and
the peripheral device encrypts the core code using the distinct information of the user terminal and decrypts the encrypted core code using the distinct information of the user terminal.

5. A method for protecting a core code using a user terminal, comprising:
receiving, by the user terminal, a normal code of an application from an application providing server in a process of downloading and installing the application from the application providing server;
performing a pairing operation with a peripheral device that stores a core code of the application received from the application providing server;
transmitting, in a process of executing the application for the first time, distinct information of the user terminal to the peripheral device to make the peripheral device encrypt the core code;
transmitting, in a process of executing the application again, the distinct information of the user terminal to the peripheral device to make the peripheral device decrypt the encrypted core code; and
transmitting an execution request message to the peripheral device, and receiving an execution result of the core code from the peripheral device.

6. The method of claim 5, further comprising:
displaying the execution result of the core code.

7. The method of claim 5, wherein,
when an execution command of the application is received for the first time, the peripheral device encrypts the core code using the distinct information of the user terminal and stores the encrypted core code, and
when the execution command of the application is received again, the peripheral device decrypts the encrypted core code using the distinct information of the user terminal, executes the decrypted core code, and transmits the execution result of the decrypted core code to the user terminal.

8. The method of claim 7, wherein the distinct information of the user terminal includes an international mobile equipment identity (IMEI), and
the peripheral device encrypts the core code using the distinct information of the user terminal and decrypts the encrypted core code using the distinct information of the user terminal.
